(19) United States
(12) Patent Application Publication
(10) Pub. No.: US 2006/0034274 A1
(43) Pub. Date: Feb. 16, 2006

(54) System and method for variable length acknowledgements in a shared resource network

(75) Inventors: Naveen Kumar Kakani, Irving, TX (US); Srinivas Sreemanthula, Flower Mound, TX (US); Yousuf Saifullah, Flower Mound, TX (US)

Correspondence Address: HAYNES AND BOONE, LLP, 901 MAIN STREET, SUITE 3100, DALLAS, TX, 75202, US

(73) Assignee: Nokia Corporation, Espoo (FI)

(21) Appl. No.: 11/192,253

(22) Filed: Jul. 28, 2005

Related U.S. Application Data
(60) Provisional application No. 60/605,580, filed on Aug. 30, 2004.
(60) Provisional application No. 60/592,414, filed on Jul. 30, 2004.

(51) Int. Cl. H04L 12/56

(52) U.S. Cl. 370/389

(57) ABSTRACT

A system and method for producing variable length acknowledgments and requesting variable length acknowledgement signals in a shared resource network is provided. A plurality of data streams and frames are received, and receipt status information of the plurality of frames is generated. An acknowledgment frame comprising the receipt status information is produced. A length of the receipt status information is dependent on a number of the plurality of frames.

### RELATED APPLICATION DATA

This patent application claims the benefit of provisional U.S. patent application Ser. No. 60/605,580, filed Aug. 30, 2004 and provisional U.S. patent application Ser. No. 60/592,414, filed Jul. 30, 2004.

### FIELD OF THE INVENTION

The present invention relates to shared resource network technologies and, more particularly, to mechanisms for enhancing channel utilization of a shared resource network. Still more particularly, the present invention provides a system and method for providing variable length acknowledgments in a shared resource network.

### BACKGROUND

Many contemporary wireless terminals are adapted to provide a wide variety of telecommunication services. For instance, a terminal may be capable of providing circuit-switched speech and data transfer services as well as packet-switched data transfer services and messaging services. These services may be provided via a common network or by different types of networks. For example, packet-switched data transfer services may be provided by a connection between a terminal and a wireless local area network (WLAN) access point. The circuit-switched services, on the other hand, may be provided by a connection between the terminal and a public land mobile network (PLMN).

WLANs are becoming increasingly popular for both business and residential applications. For instance, many companies are deploying WLANs in place of, or as an enhancement to, the corporate local area network. Additionally, many service industry businesses, e.g., restaurants and hotels, have deployed WLANs to provide customers with access to the Internet or other data networks. As WLANs have become increasingly more widespread, the number of applications designed for execution on WLAN-compliant stations has increased as well. For example, typical WLAN-compliant stations may feature text messaging applications, e-mail applications, internet browsers, and streaming content players among other applications. A user may concurrently run any number of applications on a WLAN-compliant station.

In a WLAN, a responder station is often required to acknowledge the receipt of data received from an initiator station. An acknowledgement (ACK) signal sent from a responder station to the initiator station provides a confirmation to the initiator station that the responder station correctly received transmitted data. In WLAN-compliant devices, ACKs are generated at the medium access control (MAC) layer. Such an acknowledgment mechanism consumes valuable system bandwidth. It is particularly desirable to minimize signaling and control utilization of wireless resources in a shared resource wireless network as wireless system resources are finite and limited by the system bandwidth.

Various improvements to the acknowledgment mechanism in IEEE 802.11 networks have been developed. For example, a block acknowledgment mechanism allows a responder to delay generation and transmission of an acknowledgement until a plurality of frames has been received. In this manner, a single acknowledgment frame may be conveyed from the receiver to the initiator to confirm receipt of several frames. However, this implementation requires that each frame that is acknowledged in the block acknowledgment belong to a common data stream. That is, each frame acknowledged by the block acknowledgment must be targeted to the same application or processing entity. Moreover, conventional block acknowledgements are of a fixed size and thus consume a fixed amount of the acknowledgement frame regardless of the number of frames that are being acknowledged.

### SUMMARY

It would be advantageous to provide a system and method for an improved acknowledgment mechanism in a shared resource network. It would be further advantageous to request acknowledgement (ACK) of data of multiple data streams with a single high-throughput (HT) Block ACK request signal. It would be further advantageous to provide an acknowledgment mechanism for acknowledging, by an HT Block ACK, the receipt of a plurality of frames in a shared resource network. It would still be further advantageous to provide an acknowledgment mechanism that facilitates receipt acknowledgment of frames of multiple data streams with a single acknowledgment signal. It would still be further advantageous to provide an acknowledgment mechanism that facilitates receipt acknowledgment of a variable number of frames of a variable number of data streams.

Embodiments of the present invention provide a system and method for producing variable length acknowledgments, for example variable length HT_Block ACKs, in a shared resource network. (A plurality of frames is received, and receipt status information of the plurality of frames is generated. An acknowledgment frame comprising the receipt status information is produced. A length of the receipt status information is dependent on a number of the plurality of frames.

### BRIEF DESCRIPTION OF THE DRAWINGS

Aspects of the present disclosure are best understood from the following detailed description when read with the accompanying figures.

FIG. 1 is a simplified block diagram of an exemplary network environment;

FIG. 2 is a diagrammatic representation of an embodiment of a quality of service block acknowledgment frame;

FIG. 3 is a diagram of an embodiment of a block acknowledgment frame;

FIG. 4A is a diagram of an embodiment of an acknowledgement frame that includes acknowledgement bitmap length data;

FIG. 4B is a diagram of an embodiment of a traffic identifier control field of the acknowledgement frame shown in FIG. 5A;

FIG. 4C is a diagram of an embodiment of block acknowledgement starting sequence control fields and block acknowledgement bitmap fields of the acknowledgement frame shown in FIG. 5A;

FIG. 5A is a diagram of an embodiment of a variable length acknowledgement frame that includes acknowledgement bitmap length data;

FIG. 5B is a diagrammatic representation of another embodiment of a block acknowledgement control field of a variable length acknowledgement frame described with reference to FIG. 5A;

FIG. 6 is a diagram of an embodiment of a variable length acknowledgement frame featuring implicit acknowledgement bitmap length signaling;

FIG. 7 is a diagram of an exemplary format of a block acknowledgement request frame;

FIG. 8 is a diagrammatic representation of another exemplary format of a block acknowledgement request frame;

FIG. 9 is a diagram of an embodiment of a variable length acknowledgement frame that facilitates acknowledgement of MSDUs and/or MPDUs;

FIG. 10 is a diagram of an embodiment of a variable length acknowledgement frame for providing receipt status of MSDUs that can be applied to the acknowledgement frame format described with reference to FIG. 9;

FIG. 11 is a diagram of an embodiment of a variable length acknowledgement frame for acknowledgment of a variable number of MSDUs and MPDUs;

FIG. 12 is a diagram of an embodiment of an acknowledgement frame featuring hybrid block acknowledgment control; and

FIG. 13 is a diagram of an embodiment of a frame sequence and acknowledgment sequence exchanged between initiator and responder stations.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

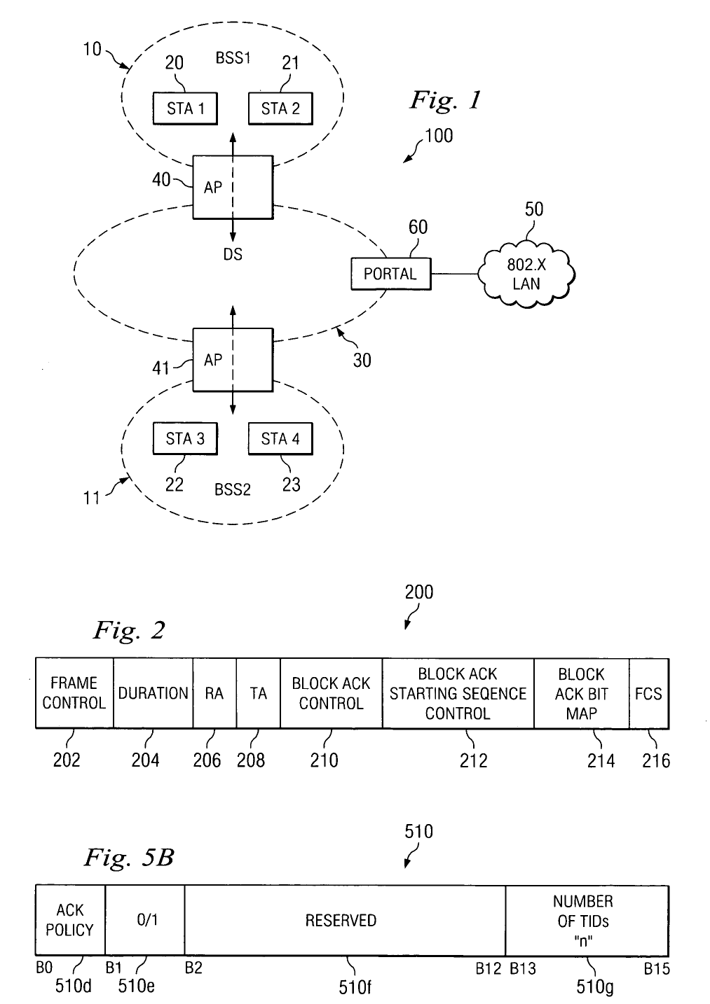

FIG. 1 is a simplified block diagram of an exemplary network 100 environment. Network 100 is an example of a shared resource network. For example, network 100 may be implemented as a wireless local area network (WLAN) conforming to the IEEE 802.11 standards. In particular, network 100 may be implemented in conformance with the IEEE 802.11n WLAN standard.

In the illustrative example, network 100 comprises two basic service sets (BSSs) 1 and 2 although any number of BSSs may be included in network 100. BSSs 1 and 2 provide respective coverage areas 10 and 11 in which WLAN stations (STAs) 20-23 may communicate via a wireless medium with one another or with other communication or computational devices in other external networks that interface with network 100. BSSs 1 and 2 are communicatively interconnected by a distribution system (DS) 30. DS 30 enables mobile device support by providing requisite logical services for handling address to destination mapping and integration of multiple BSSs. Each BSS includes an access point (AP) that provides access to DS 30. In the illustrative example, BSSs 1 and 2 have respective APs 40 and 41. DS 30 provided by APs 40 and 41 and BSSs 1 and 2 facilitate creation of a wireless network of arbitrary size and complexity, and the collection of DS 30 and BSSs 1-2 is commonly referred to as an extended service set network. Logical integration between network 100 and non-IEEE 802.11 LANs, e.g., LAN 50, is provided by portal 60. Various other configurations of network 100 are possible. For example, coverage areas 10 and 11 may partially overlap or may be collocated. Moreover, embodiments of the invention may be deployed in a WLAN comprising a single independent BSS.

Each of STAs 20-23 may be implemented as a respective data processing system adapted for communication in a wireless network, such as a wireless laptop computer, a personal digital assistant, a cellular telephone, or other device capable of data communications. A STA may comprise a processing unit, such as a general purpose microprocessor and/or an application specific integrated circuit, a memory device, such as a random access memory, a read-only memory, or another storage device for holding machine-readable data, a communication interface, such as a wireless communication card, and various other components and peripheral devices.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory in a WLAN station or a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, or any combination thereof, executing on a single computer processor or multiple computer processors. Additionally, various steps of embodiments of the invention may provide a data structure generated, produced, received, or otherwise implemented on a computer-readable medium, such as a memory.

While the descriptions of a shared resource network, devices operating therein, and wireless medium transmissions made within the shared resource network are provided herein according to EEE 802.11 protocols, functionality, and nomenclature, such examples are illustrative only and implementations of the invention are not limited to any particular network, network-compliant device, or network communication formats or protocols. Furthermore, descriptions of the invention provided herein in relation to implementations in an IEEE 802 conformant network are illustrative only and are provided only to facilitate an understanding of the invention. Embodiments of the present invention may be implemented on other network architectures and devices that utilize shared resources for effecting data communications.

FIG. 2 is a diagrammatic representation of an embodiment of a quality of service block acknowledgment (ACK) frame 200. Block ACK frame 200 is representative of a block acknowledgement frame conformant with the IEEE 802.11e specification. Block ACK frame 200 provides frame acknowledgments for frames of one traffic identifier (TID) with one signaling message. Block ACK frame 200 includes a frame control field 202, a duration field 204, a receiver address field 206, a transmitter address field 208, a block ACK control field 210, a block ACK starting sequence control field 212, a block ACK bitmap field 214, and a frame check sequence (FCS) field 216. Frame control field 202 may comprise several subfields that define, for example, a protocol version, the frame type such as data, management, or control, whether the frame is destined for the distribution system, and other frame control data. Duration field 204 may contain data that defines the duration or length of the block acknowledgement frame or association identifiers of the station that originated the block acknowledgement frame. RA field 206 and TA field 208 respectively contain a receiver address, e.g., the IEEE MAC address of the station to which block acknowledgment frame 200 is directed, and a transmitter address, e.g., the IEEE MAC address of the station that transmitted block acknowledgment frame 200. Block ACK control field 210 may comprise control data of block acknowledgment data contained in frame 200. Block ACK starting sequence control field 212 may contain a sequence number of a first frame having acknowledgement information contained in the block acknowledgement data of frame 200. Block ACK bitmap field 214 contains a bitmap that includes receipt status information of one or more frames of a TID associated with frame 200. The receipt status of the frames is preferably represented by respective binary values within the bitmap, such as a value of one (1) indicating a frame has been successfully received and a value of zero (0) indicating a frame has not been successfully received. The bitmap in a B-ACK bitmap field comprises a sequence of one or more bits that are each associated with a particular frame of a sequence of frames. A first bit of the bitmap in block ACK bitmap field 214 provides receipt status of the frame identified by the frame sequence number specified in block ACK starting sequence control field 212. Each subsequent bit in the bitmap provides receipt status for respective subsequent frames. FCS field 216 may comprise, for example, a 32-bit cyclic redundancy code.

Acknowledgment frame 200 is suitable for acknowledging multiple frames. However, Block ACK frame 200 is applicable to only one communication traffic stream identified by a TID. A traffic stream is a stream of data (e.g., voice and best effort data) associated with a certain traffic specification. Moreover, the block acknowledgement bitmap of frame 200 is of a fixed length, e.g., 128 bytes.

Thus, there is a need to enhance the Block ACK function by providing a mechanism for acknowledging frames for different TIDs for a communication station so that it can be applicable to multiple traffic streams. In this way, a communication station with multiple applications can use just one Block ACK message instead of requiring a Block ACK for each TID. Further, there is a need to enhance a Block ACK frame such that a length of the acknowledgement data may be varied according to the number of frames acknowledged thereby.

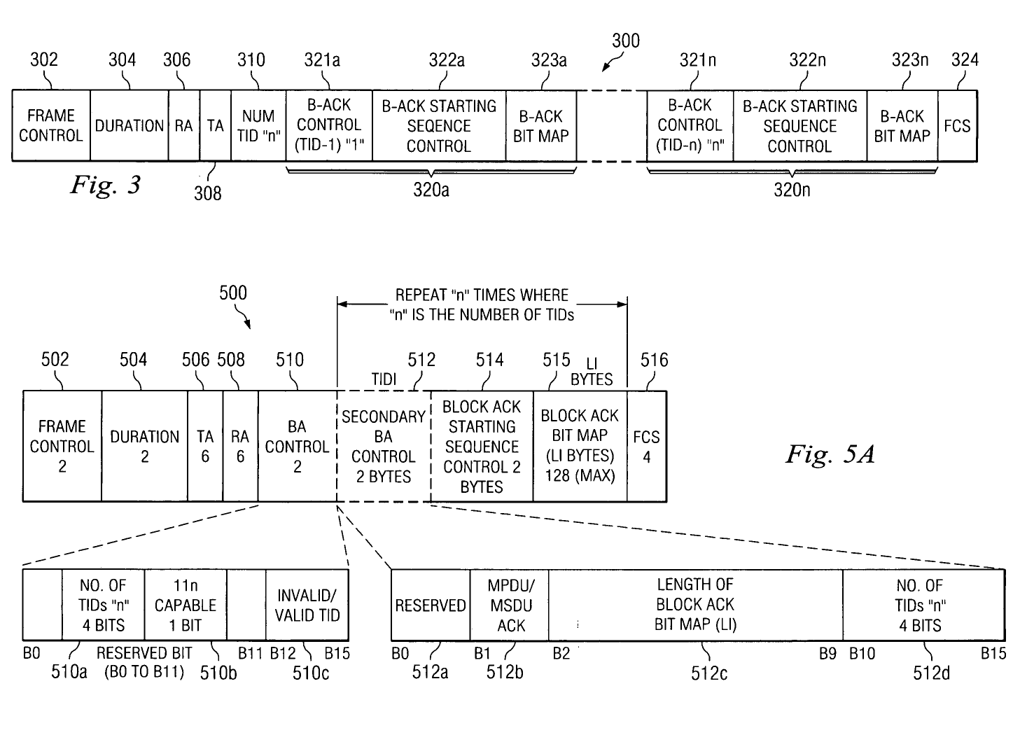

A diagram of an embodiment of an exemplary block acknowledgment frame is shown in FIG. 3. Block acknowledgement frame 300 is used to acknowledge the receipt of a plurality of traffic streams, i.e., frames of multiple TIDs. Block acknowledgement frame 300 comprises a plurality of fields. In the illustrative example, block acknowledgment frame 300 includes a frame control field 302, a duration field 304, a RA field 306, and a transmitter address (TA) field 308. Frame control field 302 may comprise several subfields that define, for example, a protocol version, the frame type such as data, management, or control, whether the frame is destined for the distribution system, and other frame control data. Duration field 304 may contain data that defines the duration or length of the block acknowledgement frame or association identifiers of the station that originated the block acknowledgement frame. RA field 306 and TA field 308 respectively contain a receiver address, e.g., the IEEE MAC address of the station to which block acknowledgment frame 300 is directed, and a transmitter address, e.g., the IEEE MAC address of the station that transmitted block acknowledgment frame 300. For a more detailed explanation of exemplary frame control field content and structure, see IEEE standard 802.11, 1999.

An optional TID count field 310 may be included that specifies the number of TIDs having frames for which block acknowledgement frame 300 confirms receipt. In the illustrative example, block acknowledgement frame 300 acknowledges the frames of n traffic streams.

Additionally, block acknowledgement frame 300 contains one or more acknowledgement field sets 320a-320n each respectively associated with one of the n TIDs. As referred to herein, a field set comprises frame identification information, such as one or more frame sequence numbers, and receipt status information of one or more frames. A field set is uniquely associated with frames of a TID (or, alternatively, with frames not associated with a TID). Each field set 320a-320n contains acknowledgement data uniquely associated with one of the TIDs and has frame receipt status acknowledged by ACK frame 300. In the illustrative example, each of field sets 320a-320n respectively comprises three fields. Particularly, each TID has an associated block-acknowledgment control field, a block acknowledgement starting sequence control field, and a block acknowledgement bitmap field. In the present example, each of the n TIDs are respectively associated with one of field sets 320a-320n that contain acknowledgment data for frames of the associated TID. Frame check sequence 324 is preferably appended to block acknowledgment frame 300.

In the present example, a block acknowledgement control field of a particular field set carries a TID to which the acknowledgement data of the field set is associated. A block acknowledgment starting sequence control field may comprise two constituent parts or subfields—a sequence number of a first frame or data unit that is to be acknowledged, and an optional fragment number of the frame or data unit specified by the sequence number. A block ACK bitmap field of a field set contains a bitmap that includes receipt status information of one or more frames for the TID associated with the field set. The receipt status of the frames is preferably represented by respective binary values within the bitmap, such as a value of one (1) indicating a frame has been successfully received and a value of zero (0) indicating a frame has not been successfully received. The bitmap in a B-ACK bitmap field comprise a sequence of one or more bits that are each associated with a particular frame of a sequence of one or more frames. A first bit of a bitmap of a particular field set provides receipt status of the frame identified by the frame sequence number of a B-ACK starting sequence control field of the field set. Each subsequent bit in the bitmap provides receipt status for corresponding sequential frames from the first frame identified by the sequence number in the B-ACK starting sequence control field.

As an example, consider field set 320a that defines acknowledgement data for frames of a traffic stream having a TID value of “1” (TID-1). In this instance, block acknowledgment control field 321a contains a TID value of “1,” and block acknowledgment starting sequence control field 322a contains a sequence number of a first frame of one or more frames of the traffic stream having the traffic identifier “1.” Block acknowledgment bitmap field 323a maintains a bitmap with bit values that respectively indicate whether one of the one or more frames of the traffic stream having a TID value of 1 have been received. For example, assume block acknowledgement starting sequence control field 322a contains a sequence number of “4000”, and assume block acknowledgement bitmap field 323a contains a bitmap of ten bit values. Accordingly, the first of the ten bit values indicates whether the frame of TID-1 having a sequence number of 4000 has been received. Each of the remaining nine bits of the bitmap respectively indicates whether one of the frames having respective sequence numbers of “4001”-“4009” have been received. The remaining field sets 320b-320n provide receipt status for frames of TIDs TID-2 through TID-n. For a more detailed description of such an acknowledgement mechanism, see co-pending U.S. patent application Ser. No. 10/895,657 filed on Jul. 21, 2004, which is hereby incorporated by reference.

In the block acknowledgement scheme depicted and described above and shown in FIG. 3, the block acknowledgment bitmaps are of a fixed size. For example, in some implementations, each block acknowledgment bitmap field 323a-323n comprises a 128-byte field. Hence, each bitmap can be used to acknowledge up to 128*8 MAC frames (MAC service data units (MSDUs), multiple MSDUs or MAC protocol data units (MPDUs)). Thus, each block acknowledgment bitmap field consumes a fixed size of block acknowledgment frame 300 regardless of the number of frames or data units for which the bitmap provides receipt status. Such an implementation results in ineffective shared resource utilization as capacity of the block acknowledgment field that is not used for frame receipt status nevertheless consumes valuable wireless medium capacity during transmission of block acknowledgement frame 300.

Therefore, it is desirable to provide techniques for acknowledging a plurality of frames of different traffic streams in a single block acknowledgment frame that has a variable size. In particular, acknowledgment frames are sent in response to different MAC Protocol Data Units (MPDUs) present in frames. The new block acknowledgment scheme allows the acknowledgement of multiple frames and accommodates traffic identifier (TID) and sequence control definitions per individual block acknowledgment frame and any fragmentation defined in the forward direction sequence control. Additionally, block acknowledgement frames are also provided for traffic frames that do not have any TID associated therewith, e.g., for MPDUs originated from legacy stations or devices that do not support multiple traffic streams.

In the embodiments described herein, various field sizes are described. However, such field size or length descriptions are illustrative only and are chosen to facilitate an understanding of the invention. Other field sizes values may also be used without departing from the teachings of the invention. For instance, a field having a particular exemplary size described herein may be implemented with a different field size in order to achieve alignment of the field with boundaries, such as a 4-bit boundary, a byte boundary, a word boundary, or a long word boundary. Such alignment may be achieved by padding the appropriate field. Additionally, field configurations provided herein are exemplary only, and various rearrangements of the order of the data fields may be made without departing from the teachings of the present invention. Numerous other variations may be implemented as will be recognized by skilled artisans.

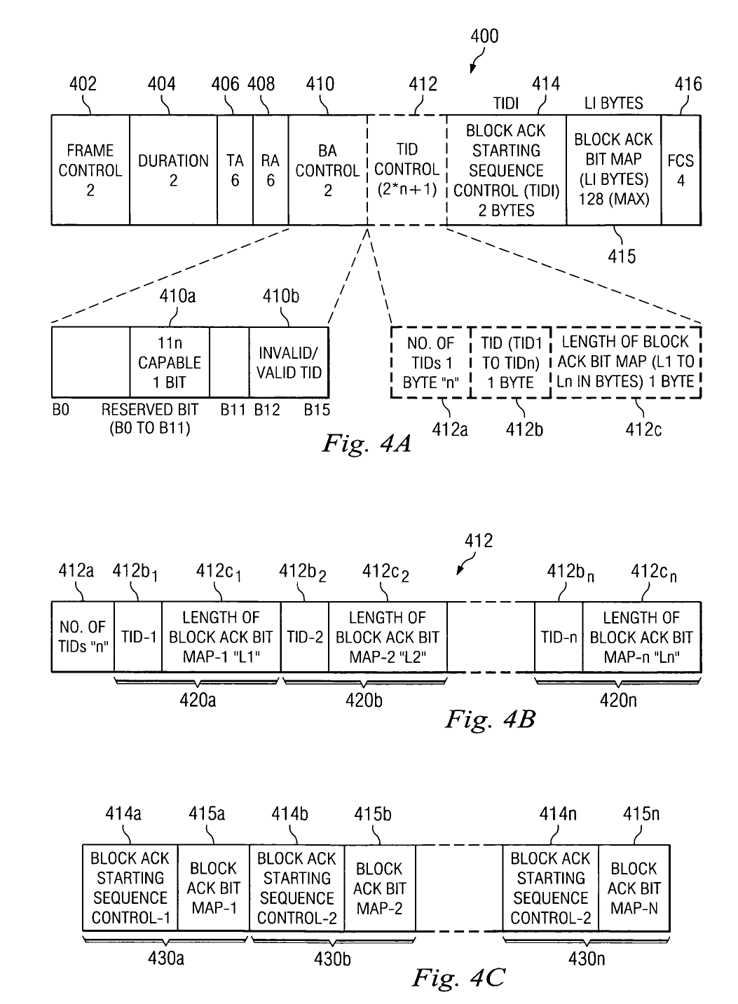

FIG. 4A is a diagram of an embodiment of a variable length ACK frame 400 that includes acknowledgement bitmap length data. In the illustrative example, ACK frame 400 may include a frame control field 402, a duration field 404, a TA field 406, a RA field 408, a block acknowledgment control field 410, and an optional TID control field 412. In the illustrative example, block acknowledgment control field 410 may comprise a 16-bit (bits B0-B15) field that includes a one-bit 11n capable field 410a and a one-bit invalid/valid TID field 410b. The 11n capable field facilitates proper interpretation of various data carried in ACK frame 400 and provides an indication of whether frame 400 is an 802.11n compliant frame. Additionally, 11n capable field 410a may be indicative of the version of the protocol or standard, such as IEEE 802.11n, with which ACK frame 400 is in compliance. In the present illustrative example, 11n capable field 410a stores a bit having a value indicative of whether particular fields, such as optional TID control field 412 and a bitmap length field, are present in ACK frame 400. For example, an 11n capable field bit value of “1” may indicate that frame TIDs are supported and thus fields identifying TID control data and fields that specify respective lengths of block acknowledgement bitmaps are included in ACK frame 400. In this instance, invalid/valid TID field 410b is set to an invalid TID value or, alternatively, invalid/valid TID field 410b may be ignored by the STA that receives ACK frame 400. TID information carried in TID control field 412 is read by the receiving STA. On the other hand, a “0” in 11n capable field 410a may indicate that invalid/valid TID field 410b is set to a valid TID value, and TID control field 412 is then excluded (as illustratively designated with dashed lines) from ACK frame 400.

In the event that field 410a is asserted, TID control field 412 is included in ACK frame 400 and may comprise a TID count field 412a and one or more field sets each comprising an instance of TID identifier field 412b and corresponding length of block acknowledgement bitmap field 412c. Additionally, an optional MSDU/MPDU bit field 412d may be included that indicates if the ACK bitmap is acknowledging either MSDUs, MPDUs or a MAC frame. TID count field 412a includes a numerical identifier of the number n of TIDs with frames having the receipt status acknowledged by ACK frame 400, and TID identifier field 412b conveys the TID value. For each TID having frame receipt status in ACK frame 400, a corresponding field set of TID identifier field 412b and length of block acknowledgement bitmap field 412c is included in TID control field 412. For example, FIG. 4B is a diagram of an embodiment of TID control field 412 of ACK frame 400. As described above, TID control field 412 includes TID count field 412a that provides a numerical specification of the number of TIDs having frames with receipt status identified by ACK frame 400. In the illustrative example, TID count field 412a has a value of “n” thus specifying frames of n TIDs are acknowledged by ACK frame 400. Accordingly, n sets of TID identifier fields and corresponding length of block acknowledgement bitmap fields are included in TID control field 412. In the illustrative example, TID identifier field and length of block acknowledgement bitmap field sets 420a-420n are included in TIE) control field 412. Each of field sets 420a-420n are associated with one of the n TIDs. For example, TID field 412b₁ contains a value (“1”) that identifies a particular TID (TID-1). Length of block acknowledgement bitmap field 412c₁ specifies the length of a block acknowledgement bitmap associated with TID-1 identified in TID field 412b₁. In the illustrative example, length of block acknowledgement bitmap field 412c₁ specifies a length value of “L1” of the bitmap associated with TID-1. The length value, for example, may specify the length L1 of the bitmap in bytes. Likewise, TID fields and length of block ACK bitmap fields of field sets 420b-420n respectively identify a TID and a corresponding block acknowledgement bitmap field length for one of the n TIDs having frames acknowledged by ACK frame 400.

Returning again to FIG. 4A, ACK frame 400 may include n field sets of block ACK starting sequence control field 414 and block ACK bitmap field 415. Each of the n field sets of block ACK starting sequence control field 414 and block ACK bitmap field 415 are uniquely associated with one of the n TIDs having frames with receipt status acknowledged by ACK frame 400. A block ACK starting sequence control field specifies a sequence number of a first frame of a frame sequence having receipt status thereof defined in the corresponding block ACK bitmap field. The length of each block ACK bitmap is preferably variable and is set according to a corresponding length of block ACK bitmap field in TID control field 412.

With reference now to FIG. 4C, there is shown a diagram of an embodiment of block ACK starting sequence control fields and block ACK bitmap fields of ACK frame 400. As shown, ACK frame 400 includes field sets 430a-430n each having a respective block ACK starting sequence control field 414a-414n and an associated block ACK bitmap field 415a-415n. Each field set 430a-430n is uniquely associated with one of the n TIDs. In the illustrative example, block ACK starting sequence control data is designated as Block ACK starting sequence control-X, and block ACK bitmap data is designated as Block ACK bitmap-X, where X designates the TID with which the starting sequence control data and block ACK bitmap are associated. For example, starting sequence control data in block ACK starting sequence control field 414a and block ACK bitmap data in block ACK bitmap field 415a are associated with a TID of “1.” Thus, block ACK starting sequence control field 414a identifies a sequence number of a first frame of TID-1 that has receipt status data in the block ACK bitmap of block ACK bitmap field 415a. Additional sequential frames (if any) of TID-1 have corresponding receipt status in sequential order in block ACK bitmap field 415a. The length of the bitmap in block ACK bitmap field 415a is specified by the associated length of block ACK bitmap field in TID control field 412. In the illustrative example, the length of the block ACK bitmap in block ACK bitmap field 415a is specified by length of block ACK bitmap field 412c₁ (shown in FIG. 4B) in TID control field 412. In a similar manner, lengths of the block ACK bitmaps in block ACK bitmap fields 415b-415n are respectively specified in length of block bitmap fields 412c₂-412cₙ that are associated with the bitmaps by way of corresponding TID values. Thus, ACK frame 400 provides a frame format for acknowledgments of multiple traffic streams. A variable number of frame acknowledgments is provided by ACK frame 400 on a per TID basis.

With reference now to FIG. 5A, there is shown a diagram of an embodiment of a variable length ACK frame 500 that includes acknowledgement bitmap length data. In the illustrative example, ACK frame 500 may include a frame control field 502, a duration field 504, a TA field 506, a RA field 508, and a block acknowledgment control field 510.

In the illustrative example, block acknowledgment control field 510 comprises a 16-bit (bits B0-B15) field that may include a four-bit TID count field 510a, a one-bit 11n capable field 510b, and invalid/valid TID field 510c. Notably, ACK frame 500 does not include a TID control field. Rather, the number of TIDs having frames with receipt status identified by ACK frame 500 is specified in block acknowledgment control field 510, and the length of block acknowledgment bitmaps in ACK frame 500 are specified in an optional secondary block acknowledgment control field. In one embodiment, when the 11n capable field bit is set (e.g., to a value “1”) and the number of TIDs having frames with receipt status data specified by ACK frame 500 is equal to 1, invalid/valid TID field 510c of block acknowledgment control field 510 is set to the valid value of the TID having frames with receipt status identified by ACK frame 500. In this instance, secondary block acknowledgment control field 512 is not included in ACK frame 500 (as illustratively designated by dashed lines). In this case, the length of the block ACK bitmap is variable and ACK frame 500 does not need to explicitly identify the block ACK bitmap length. Rather, the length of block ACK bitmap field 515 may be implicitly determined by subtracting the length of the frame fields (excluding block ACK bitmap field 515) from the overall length of ACK frame 500.

In another embodiment, when 11n capable field 510b is set and the number of TIDs identified in TID count field 510a is greater than “1”, invalid/valid TID field 510c is set to an invalid TID value or, alternatively, invalid/valid TID field 510c is ignored. In this instance, secondary block acknowledgment control field 512 is included in ACK frame 500 as shown in FIG. 5A. In the illustrative example, secondary block acknowledgment control field 512 comprises a 4-bit reserved field 512a, and may optionally include an MSDU/MPDU bit field 512b that indicates if the ACK bitmap is acknowledging either MSDUs, MPDUs or MAC frames. Additionally, secondary block acknowledgment control field 512 may comprise a length of block acknowledgement bitmap field 512c, and TID identifier field 512d. The illustrative example shows a single instance of secondary block acknowledgement control field 512, block ACK starting sequence control field 514, and block ACK bit map field 515 to simplify the illustration. However, multiple instances of these fields are respectively included in ACK frame 500 each associated with one of the n TIDs, and each instance of the secondary block acknowledgement control field 512, block ACK starting sequence control field 514, and block ACK bitmap field 515 corresponds to one of the n TIDs having frame receipt status identified by ACK frame 500. Accordingly, instances of secondary block acknowledgment field 512 specify respective lengths of block ACK bitmaps of associated TIDs.

When the 11n capable field 510b is set to another value, e.g., “0”, then invalid/valid TID field 510c is set to a valid TID value, secondary block acknowledgement control field 512 is not included in ACK frame 500 (as illustratively designated by dashed lines), and the length of the block ACK bitmap can be of variable length. In this instance, frames of a single TID are acknowledged by variable length block ACK bitmap field 515.

With reference now to FIG. 5B, a diagram of another embodiment of block acknowledgement control field 510 of variable length ACK frame 500 is shown. Block acknowledgement control field 510 may comprise a 16-bit (bits B0-B15) field that may include an acknowledgement bit (B0) field 510d, a control bit (B1) field 510e, a reserved field 510f; and a TID count field 510g. Acknowledgment bit field 510d may be set to a particular value (e.g., “0”) to indicate that a normal or non-delayed acknowledgement is requested by request frame 500. That is, an acknowledgement bit field 510d value of “0” may indicate that frame 500 is a non-delayed acknowledgement. An acknowledgement bit field 510d of another value (e.g., “1”) may indicate that frame 500 was not generated in immediate response to receipt of an acknowledgement request. Control field 510e may be set to a particular value (e.g., “1”) to provide a mechanism for interpreting acknowledgment frame 500 without an invalid/valid TID field 510c shown in FIG. 5A. In this configuration, a control bit field 510d value of “1” may indicate that block acknowledgement control field 510 includes an identification of the number of TIDs in TID count field 510g.

The ACK frame formats shown in FIGS. 4A-4C and 5A-5B may also be applied and/or overlaid with other frame formats. Furthermore, ACK frame formats shown in FIGS. 4A-4C and 5A-5B may also be applied to frame formats for acknowledgement of MSDUs as shown and described more fully hereinbelow.

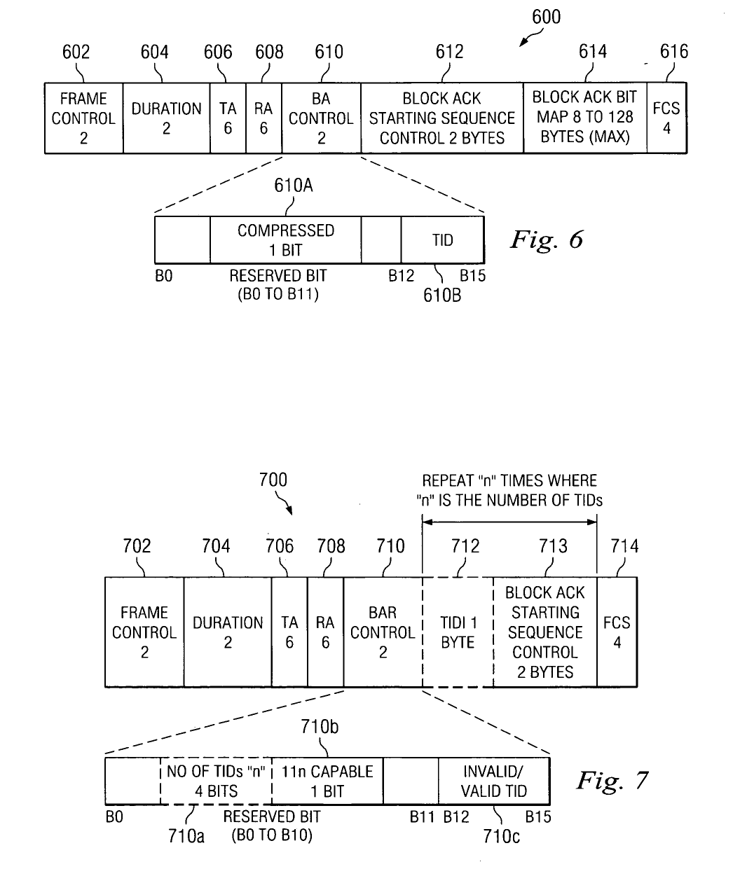

With reference now to FIG. 6, a diagram of an embodiment of a variable length ACK frame 600 featuring implicit acknowledgement bitmap length signaling is shown. In this implementation, ACK frame 600 includes a frame control field 602, a duration field 604, a TA field 606, a RA field 608, and a block acknowledgment control field 610. In the illustrative example, block acknowledgment control field 610 comprises a 16-bit (bits B0-B15) field that includes compressed bit field (MSDU/MPDU acknowledgement) 610a, and TID identifier field 610b. In this embodiment, ACK frame 600 supports acknowledgments of a variable number of frames of a single TID. Block acknowledgement starting sequence control field 612 identifies the sequence number of a first frame of the single TIED that is acknowledged by ACK frame 600. The length of a bitmap contained in block acknowledgment bitmap field 614 is implicitly determined (or can be explicitly indicated in another embodiment) by determining the total length of ACK frame 600 and subtracting the overhead bytes of ACK frame 600. That is, the length of block acknowledgment bitmap field 614 delimited by block ACK starting sequence control 612 and FCS 616 is determined by subtracting the length of fields 602-612 and FCS 616 from the overall length of ACK frame 600. Additionally, the ACK frame formats described above in FIGS. 5A-5C and 6 may also be applied to the ACK frame format of FIG. 6. In another embodiment, compressed bit field 610a can optionally include the block ACK bitmap length in bytes (for example, by using 7 bits of bits B0-B11 for this purpose).

The above-described embodiments of variable length acknowledgement frames introduce the flexibility for acknowledgement of 1 to 128*8 frames (MSDUs or MPDUs). As noted above, prior acknowledgement solutions have provided mechanisms with fixed length ACK bitmaps, e.g., 128 byte acknowledgement bitmaps, for each TID. However, the probability of needing to acknowledge 128*8 MPDUs is clearly unlikely and such a situation would infrequently occur. The explicit or implicit inclusion of the length of an ACK bitmap decreases the amount of bits to be transmitted in an ACK and therefore requires lower overhead compared to other solutions described herein. Thus, these frame formats result in increased data throughput and more efficient utilization of network resources. The aforedescribed embodiments include enhancements to ACK frames transmitted by a station that is acknowledging receipt of packets.

With reference now to FIG. 7, a diagram of an exemplary format of a block ACK request frame 700 is shown. Block ACK request frame 700 may be transmitted by an originating station requesting an acknowledgement from a receiving station that has received information packets from the originating station. Block ACK request frame 700 includes a frame control field 702, a duration field 704, a TA field 706, a RA field 708, and a block acknowledgment request (BAR) control field 710. In the illustrative example, block acknowledgement request control field 710 comprises a 16-bit (bits B0-B15) field that may include an optional TID count field 710a (illustratively designated with dashed lines). An 11n capable bit field 710b and an invalid/valid TID field 710c are included in block acknowledgement request control field 710.

In the event that ACK request frame 700 is generated by the originator for acknowledgement of frames of a single TID, the 11n capable field 710b may be set (e.g., to a bit value of “1”), and invalid/valid TID field 710c is set to the value of the TID with which the frames to be acknowledged are associated. Additionally, optional TID count field 710a may be set to “1” to indicate ACK request frame 700 is a request for acknowledgement of frames of a single traffic stream. When ACK request frame 700 is used to request acknowledgement of frames of a single TID, optional TID identifier field 712 (illustratively designated with dashed lines) is preferably excluded from ACK request frame 700. TID identifier field 712 may be excluded in such a situation as an identification of the TID is provided by invalid/valid TID field 710c. Thus, block ACK starting sequence control 713 includes the sequence number of the start frame of one or more frames to be acknowledged of the single TID. Also, an additional bit can be used in block acknowledgement request control field 710 and/or in the field 712, to indicate if the requested ACK bitmap is a compressed bitmap (for acknowledgment of MSDUs or MPDUs). ACK request frame 700 is appended with FCS 714.

Alternatively, the originator or requesting station may set 11n capable field 710b to a different value, e.g., “0”. In this instance, invalid/valid TID field 710c is set to a valid TID value regardless of the number of TIDs.

In the event that the 11n capable bit field 710b is set to indicate the originator is an EEE 802.11n compliant station and in the event that the number of TIDs is greater than one, optional TID count field 710a may be set to indicate the number n of TIDs for which acknowledgement of frames is requested. Invalid/valid TID field 710c is set to an invalid TID value or, alternatively, the invalid/valid TID field 710c may be ignored. Field sets of TID identifier field 712 and block ACK starting sequence control 713 are then included for each TID. The illustrative example shows a single instance of TID identifier field 712 and block acknowledgement starting sequence control field 713 to simplify the illustration. When ACK request frame 700 is a request for acknowledgment of multiple TID frames, multiple field sets of TID identifier field 712 and block acknowledgement starting sequence control field 713 are included in ACK request frame 700, and each instance of a field set is uniquely associated with one of the n TIDs. Also, a bit may be included in TID identifier field 712 to indicate if the requested ACK bitmap if a compressed bitmap (for acknowledging MSDUs/MPDUs).

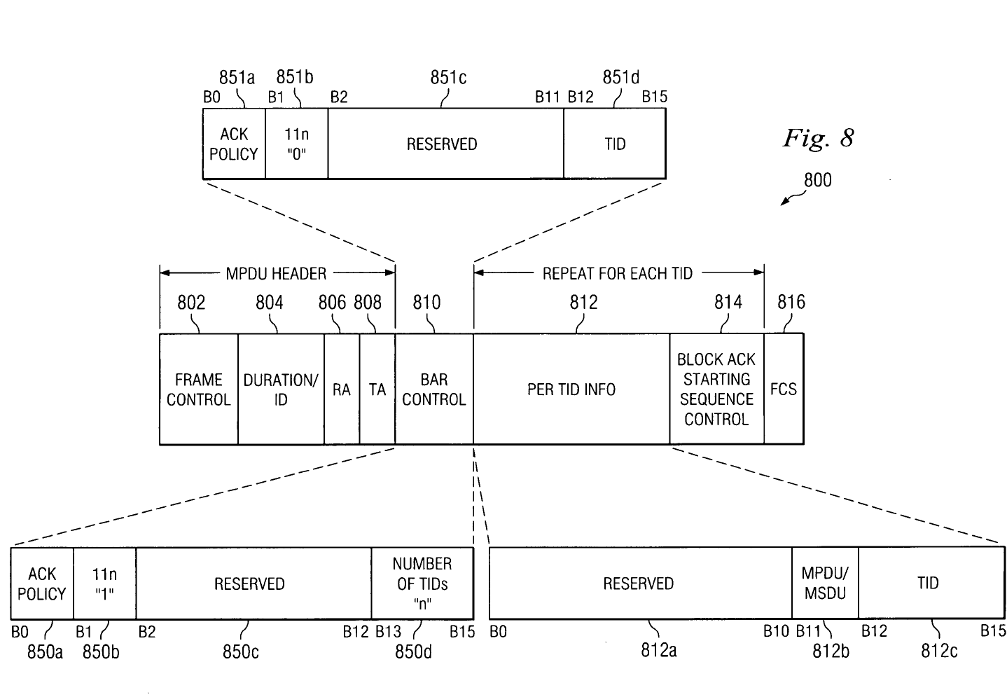

With reference now to FIG. 8, there is shown a diagram of another exemplary format of a block ACK request frame 800. Block ACK request frame 800 may be transmitted by an originating station requesting an acknowledgement from a receiving station that has received information packets from the originating station. Block ACK request frame 800 includes an MPDU header comprising a frame control field 802, a duration field 804, an RA field 806, and a TA field 808. Additionally, request frame 800 may include a block acknowledgment request (BAR) control field 810, one or more sets of a per TID information field 812 and a respective block acknowledgement starting sequence control field 814 associated therewith, and an FCS 816.

BAR control field 810 may be implemented in one of multiple configurations. For example, BAR control field 810 may be implemented in an 802.1 In compliant configuration 850 or a non-802.11n compliant configuration 851. For example, if configured in an 802.11n compliant configuration, BAR control field 810 may comprise a 16-bit (bits B0-B15) field that may include an acknowledgement bit (B0) field 850a, an 11n capable bit (B1) field 850b, a reserved field 850c, and a TID count field 850d. Acknowledgment bit field 850a may be set to a particular value (e.g., “0”) to indicate that a normal or non-delayed acknowledgement is requested by request frame 800. That is, an acknowledgement bit field 850a value of “0” may indicate that request frame 800 is sent from a sender that needs an immediate acknowledgement, and that the receiver of request frame 800 is to return acknowledgement information to the sender of request frame 800 as soon as possible, e.g., after a suitable SIFS period. An acknowledgement bit field 850a of another value (e.g., “1”) may indicate that the receiver of request frame 800 is not required to perform any immediate action upon receipt of request frame 800. The acknowledgement bit field 850a may be set to “1” when the sender of request frame 800 does not require immediate, explicit acknowledgement information. In the 802.11n compliant configuration 850, 11n capable field 850b may be set to a particular value (e.g., to a value of “1”) to indicate frame 800 is an 802.11n compliant request. Bits B13-B15 of TID count field 850d are set to a value to identify the number, n, of TIDs for which acknowledgement information is requested. In this configuration, request frame 800 will include n sets of per TID information field 812 and BA starting sequence control field 814 with each set corresponding to one of the n TIDs.

BAR control field 810 may be implemented in non-802.11n compliant configuration 851. For example, if configured in a non-802.11n compliant configuration, BAR control field 810 may comprise a 16-bit (bits B0-B15) field that may include an acknowledgement bit (B0) field 851a, an 11n capable bit (B1) field 851b, a reserved field 851c, and a TID identifier field 851d. Acknowledgment bit field 851a may be set to a particular value (e.g., “0”) to indicate that a normal or non-delayed acknowledgement is requested by request frame 800, and another value (e.g., “1”) may indicate that the receiver of request frame 800 is not required to perform any immediate action upon receipt of request frame 800. In non-802.11n compliant configuration 851, 11n capable field 851b may be set to a particular value (e.g., to a value of “0”) to indicate frame 800 is not an 802.11n compliant request, e.g., the request frame 800 may be interpreted as an 802.11e request frame. Bits B12-B15 of TID identifier field 851d are set to a TID value for which acknowledgement information is requested. In this configuration, request frame 800 will include a single set of per TID information field 812 and BA starting sequence control field 814 each corresponding to the TID identified in TID identifier field 851d.

Per TID Information field 812 may comprise a reserved field 812a (bits B0-B10), an MPDU/MSDU bit (B11) field 812b, and a TID identifier field 812c (bits B12-B15). MPDU/MSDU bit field 812b may be set to a particular value (e.g., “0”) to indicate that frame 800 comprises a request for acknowledgement information of MPDUs, and may be set to another value (e.g., “1”) to indicate frame 800 is a request for acknowledgement information of MSDUs. TID identifier field 812c may specify a value of a TID for which the acknowledgement request is provided. A starting sequence number for which acknowledgement information is requested is specified in an instance of BA starting sequence control field 814 associated with an instance of Per TID information field 812. Thus, if acknowledgement information is requested for n TID, n sets of Per TID information field 812 and a respective BA starting sequence control field 814 associated therewith are included in request frame 800.

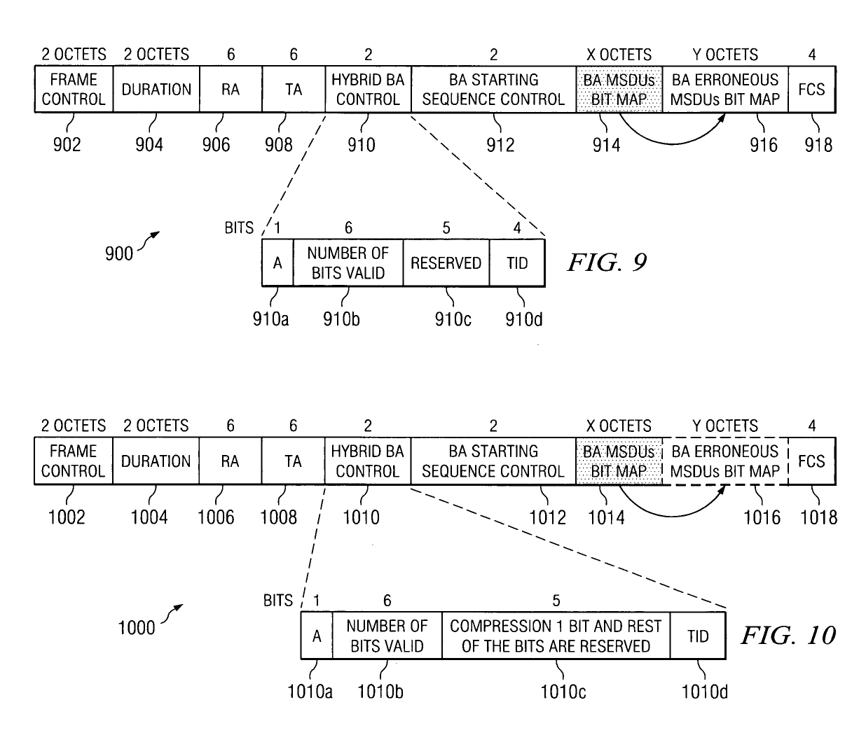

With reference now to FIG. 9, a diagram of an embodiment of an ACK frame 900 that facilitates acknowledgement of MSDUs and/or MPDUs is shown. ACK frame 900 includes a control field 902, a duration 904, a RA field 906, a TA field 908, and a hybrid block acknowledgment control field 910. Additionally, ACK frame 900 includes block acknowledgement starting sequence control field 912, block acknowledgment MSDUs bitmap field 914, block acknowledgment erroneous MSDUs bitmap field 916, and FCS 918.

In this embodiment, hybrid block acknowledgement control field 910 includes various subfields. Particularly, hybrid block acknowledgement control field 910 includes acknowledgment field 910a, number of bits valid field 910b, reserved field 910c, and TID identifier field 910d. Acknowledgement field 910a is a single bit field that identifies whether an entire sequence of MSDUs have been successfully received. For example, a bit value of “1” in acknowledgement field 910a may affirm receipt of an MSDU sequence, while a value of “0” may indicate that the complete sequence of MSDUs has not been successfully received. The sequence of MSDUs is defined by a block acknowledgement starting sequence control field 912 and number of bits valid field 910b. Particularly, block acknowledgement starting sequence control field 912 specifies a sequence number of a first MSDU of an MSDU sequence. Number of bits valid field 910b may be a fixed length bit field, e.g., a 6-bit field, and has a value that indicates the length of a block acknowledgement bitmap maintained in block acknowledgement MSDU bitmap field 914. For example, when the value of number of bits valid field 910b ranges from 56 to 63, the length (in octets) of the block acknowledgement MSDU bitmap field 914 is “8”.

Additionally, block acknowledgement MSDU bitmap field 914 provides a mechanism for indicating whether all fragmented MPDUs within the MSDU sequence have been successfully received or not. For example, a bit Bm, (i.e., the m^{th} bit in block acknowledgement MSDU bitmap field 914) indicates whether all the fragmented MPDUs within the MSDU with a sequence number comprising the sum of the sequence number specified in block acknowledgement starting sequence control field 912 and m have been successfully received or not.

Additionally, block acknowledgement erroneous MSDU field 916 indicates the erroneous MPDUs within erroneous MSDUs. The length of the block acknowledgement erroneous MSDU field 916 is a multiple of all the erroneous MSDUs being acknowledged by ACK frame 900. For example, if an MSDU comprises 16 MPDUs, then the length of the block acknowledgement erroneous MSDU field 916 is 16 bits (i.e., 2 octets).

With reference now to FIG. 10, there is shown a diagram of an embodiment of an ACK frame 1000 for providing receipt status of MSDUs that may be applied to the ACK frame 900 format described above with reference to FIG. 9. ACK frame 1000 includes a control field 1002, a duration field 1004, a RA field 1006, a TA field 1008, and a hybrid block acknowledgement control field 1010. Hybrid block acknowledgment control field 1010 includes various subfields. In the illustrative example, hybrid block acknowledgement control field 1010 may include an acknowledgment field 1010a, a number of bits valid field 1010b, a compression and reserved bit field 1010c, and a TID identifier field 1010d. Additionally, ACK frame 1000 may include a block acknowledgement starting sequence control field 1012, a block acknowledgment MSDU bitmap field 1014, a block acknowledgement erroneous MSDU bitmap field 1016, and a FCS 1018. A compression bit in compression and reserved bit field 1010 is optional. If a compression bit is included in compression and reserved bit field 1010c, ACK frame 1000 provides acknowledgements of MSDUs rather than fragments of MSDUs. Accordingly, if the compression bit is included and is set (e.g., to a bit value of ‘1’), the length of block acknowledgement erroneous MSDU field 1016 is 0 bytes, that is block acknowledgment erroneous MSDU bitmap field is excluded from ACK frame 1000 (as illustratively designated by dashed lines). If the compression bit is set to another value, e.g., a bit value of ‘0’, ACK frame 1000 includes block acknowledgement erroneous MSDU field 1016. In this instance, ACK frame 1000 provides acknowledgement functionality as that of ACK frame 900 shown and described in FIG. 9.

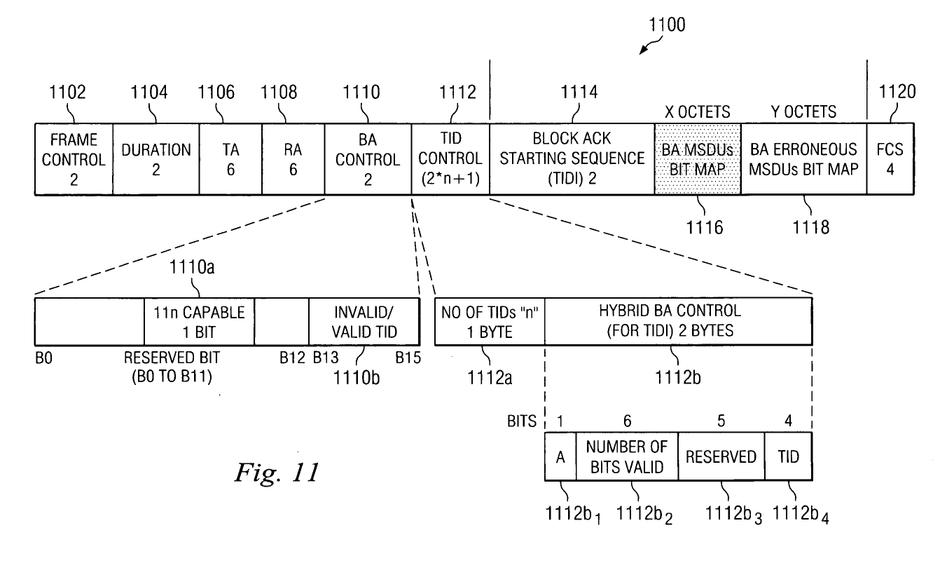

With reference now to FIG. 11, a diagram of an embodiment of a variable length ACK frame 1100 for acknowledgment of a variable number of MSDUs and MPDUs is shown. ACK frame 1100 may include a frame control field 1102, a duration field 1104, a TA field 1106, a RA field 1108, and a block acknowledgment control field 1110. Block acknowledgement control field 1110 may include various subfields. Particularly, block acknowledgment control field 1110 may comprise a 16-bit (bits B0-B15) field that includes 11n capable bit field 1110a and invalid/valid TID field 1110b. Additionally, ACK frame 1100 may include TID control field 1112 that includes the subfields TID count field 1112a and hybrid block acknowledgment control field 1112b. Hybrid block acknowledgment control field 1112b may include the subfields acknowledgment bit field 1112b₁, number of bits valid field 1112b₂, reserved field 1112b₃, and TID identifier field 1112b₄. Additionally, ACK frame 1100 may include n TID field sets that each respectively comprise an instance of block acknowledgement starting sequence field 1114, block acknowledgment MSDU bitmap field 1116, and block acknowledgment erroneous MSDU bitmap field 1118. ACK frame 1100 is appended with FCS 1120.

TID count field 1112a specifies the number n of TIDs that have MSDUs or MPDUs acknowledged by ACK frame 1100. For each instance of TID field sets comprising a block ACK starting sequence field 1114, block acknowledgement MSDU bitmap field 1116, and block acknowledgment erroneous MSDU bitmap field 1118, a corresponding instance of hybrid block acknowledgement control field 1112b is used to indicate the length of the block acknowledgement MSDU bitmap field 1116.

When 11n capable field 1110a is set (e.g., to a bit value of “1”), invalid/valid TID field 1110b is set to an invalid TID value (or, alternatively, invalid/valid TID field 1110b may be ignored). In this instance, TID control field 1112 comprising the hybrid block acknowledgement control field is included in ACK frame 1100. However, when the 11n capable field value is set to another value (e.g., a bit value of “0”), the bits in the block acknowledgement control field 1110 are interpreted as hybrid block acknowledgement control field data. In this instance, the 11n capable bit comprises one of the reserved bits in the hybrid block acknowledgement control data.

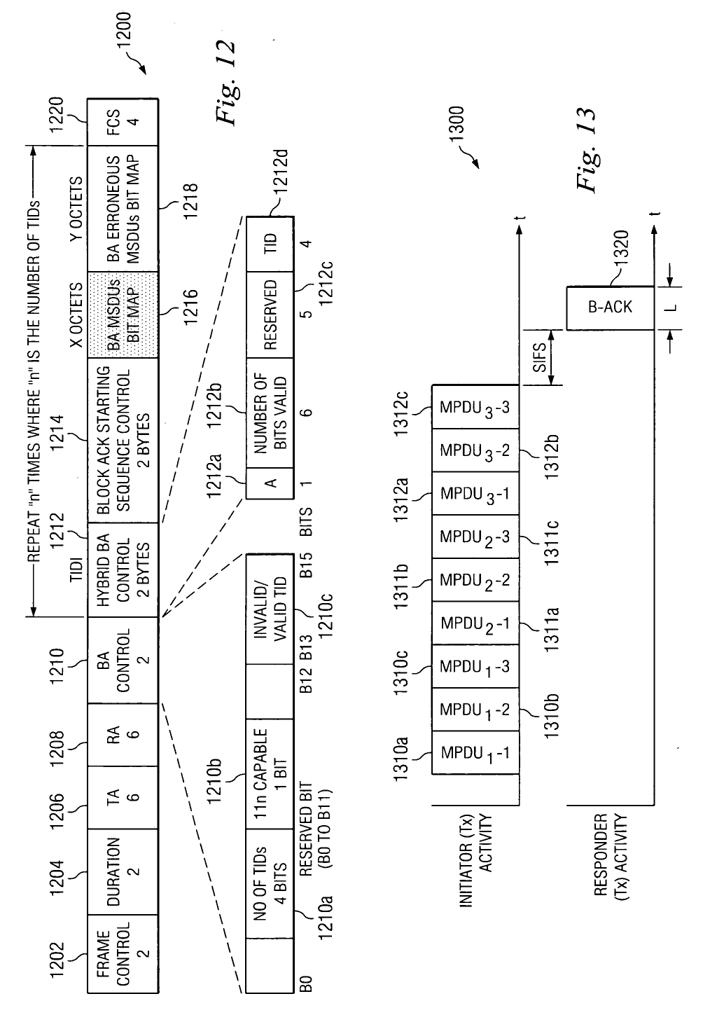

With reference now to FIG. 12, a diagram of an embodiment of a variable length ACK frame 1200 having hybrid block acknowledgment control is shown. ACK frame 1200 may include a frame control field 1202, a duration field 1204, a TA field 1206, a RA field 1208, and a block acknowledgment control field 1210. Block acknowledgement control field 1210 may include various subfields. Particularly, block acknowledgment control field 1210 may comprise a 16-bit (bits B0-B15) field that includes a TID count field 1210a, an 11n capable bit field 1210b, and an invalid/valid TID field 1210c. Additionally, ACK frame 1200 includes n TID field sets that each comprise respective instances of hybrid block acknowledgement control field 1212, block acknowledgment starting sequence control field 1214, block acknowledgement MSDU bitmap field 1216, and block acknowledgment erroneous MSDU bitmap field 1218. Each instance of hybrid block acknowledgement control field 1212 includes various subfields including acknowledgement bit field 1212a, number of bits valid field 1212b, reserved bit field 1212c, and TID identifier field 1212d. ACK frame 1200 is appended with FCS 1220.

Each instance of hybrid block acknowledgement control field 1212 indicates the length of block acknowledgement MSDU bitmap field 1216 of a corresponding TID. When 11n capable field 1210b is set to one value (e.g., a bit value of “1”) and the number of TIDs indicated by TID count field 1210a is greater or equal to 1, then invalid/valid TID field 1210c is set to an invalid TID value (or, alternatively, invalid/valid TID field 1210c may be ignored). In this instance, the hybrid block acknowledgement control field 1212 is included in the frame structure shown in FIG. 12. When 11n capable field 1210b is set to another value (e.g., a bit value of “0”), then the bits of block acknowledgement control field 1210 are interpreted as hybrid block acknowledgement control data. In this case, the 11n capable bit is one of the reserved bits in the hybrid block acknowledgment control field.

With reference now to FIG. 13, a diagram of an embodiment of a frame sequence and acknowledgment exchanged between initiator and responder stations is shown. In the illustrative example, an initiator, such as WLAN station 20 shown in FIG. 1, transmits frame sequence 1300 comprising a plurality of frames 1310a-1312c to a responder station, such as WLAN station 23 shown in FIG. 1. Frames 1310a-1312c are representative of frames that contain MAC protocol data units of various traffic streams and are illustratively designated as MPDUx-Y, where X designates a traffic stream and Y designates a frame number. As referred to herein, a frame subset comprises a subset of a frame sequence and has one or more frames belonging to a particular traffic stream. Thus, a frame subset comprising three frames 1310a-1310c of a traffic stream “1” are shown transmitted from an initiator station to a responder station. Likewise, respective frame subsets of three frames 1311a-1311c and 1312a-1312c of traffic streams “2” and “3” are shown transmitted from the initiator station to the responder station. Optionally, at the end of data for each traffic stream the initiator can transmit a HT-Block-ACK request to request an explicit HT-Block ACK.

In accordance with a preferred embodiment of the present invention, a variable length ACK frame 1320 is transmitted by the responder station responsive to the receipt of frame sequence 1300 which could optionally include an HT Block-ACK request. HT-ACK frame 1300 is adapted to acknowledge frames of one or more TIDs (or, alternatively, frames not associated with a TID). As described above, the field lengths of ACK frame 1320 that include acknowledgment information regarding the receipt status of frame sequence 1300 are dependent on the number of frames of frame sequence 1300 being acknowledged. Thus, the length (as measured in bits, bytes, or the like) of ACK frame 1320 is variable and dependent on the number of frames being acknowledged. Consequently, the length L as a duration of time that ACK frame 1320 consumes a wireless medium resource, e.g., one or more channels, is dependent on the number of frames being acknowledged by ACK frame 1320.

While FIG. 13 depicts a single ACK being sent for acknowledgment of multiple TIDs and multiple MPDUs per TID that are received by a station, it should be understood that a variable length ACK frame may be sent for a group of one or more MPDUs for each TID, or an ACK frame may be sent for a group of one or more MPDUs of different TIDs without departing from the spirit of the invention. As described, mechanisms are provided by embodiments described herein for producing variable length acknowledgement frames. A plurality of frames is received by a responder station, and receipt status information regarding the plurality of frames is generated thereby. An acknowledgement frame is produced that includes the receipt status information. The length of the receipt status information, and thus the overall length of the acknowledgment frame, is dependent on a number of the plurality of frames that were received by the responder station.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method of generating frame acknowledgement information, comprising:
receiving a plurality of frames;
generating receipt status information regarding the plurality of frames; and
producing an acknowledgment frame comprising the receipt status information, wherein a length of the receipt status information is dependent on a number of the plurality of frames.

2. The method of claim 1, wherein receiving the plurality of frames comprises receiving a plurality of frame subsets each associated with one of a plurality of traffic identifiers.

3. The method of claim 2, further comprising generating a plurality of field sets of the acknowledgment frame each respectively associated with one of the plurality of traffic identifiers, wherein each field set includes at least one sequence number and receipt status information of frames of an associated traffic identifier, and wherein receipt status information of a field set is of a length that is dependent on a number of frames of the associated traffic identifier having recipient status indicated in the acknowledgement frame.

4. The method of claim 3, wherein the receipt status information in each field set respectively comprises a block acknowledgement bitmap.

5. The method of claim 3, wherein the at least one sequence number included in each field set respectively comprises a sequence number of a first frame of the associated traffic identifier having a receipt status in the receipt status information of the field set.

6. The method of claim 3, further comprising producing a respective length field in the acknowledgment frame for each field set that specifies a length of the receipt status information included in the field set.

7. The method of claim 1, wherein the plurality of frames comprise a plurality of MAC service data units or MAC protocol data units.

8. The method of claim 1, further comprising producing a length field in the acknowledgment frame that specifies the length of the receipt status information.

9. A computer-readable medium having computer-executable instructions for execution by a computer system, the computer-executable instructions for performing a method of generating frame acknowledgment information, the computer-executable instructions comprising:
first instructions that receive a plurality of frames;
second instructions that generate receipt status information regarding the plurality of frames; and
third instructions that produce an acknowledgment frame comprising the receipt status information, wherein a length of the receipt status information is dependent on a number of the plurality of frames.

10. The computer-readable medium of claim 9, wherein the plurality of frames received by the first instructions comprises a plurality of frame subsets each respectively associated with one of a plurality of traffic identifiers.

11. The computer-readable medium of claim 10, further comprising fourth instructions that produce a plurality of field sets in the acknowledgement frame each respectively associated with one of the plurality of traffic identifiers, wherein each field set includes at least one sequence number and receipt status information of frames of the associated traffic identifier, and wherein the receipt status information of a field set has a length that is dependent on a number of frames of the associated traffic identifier.

12. The computer-readable medium of claim 11, wherein the receipt status information in each field set respectively comprises a block acknowledgement bitmap data structure.

13. The computer-readable medium of claim 11, wherein the at least one sequence number included in each field set respectively comprises a sequence number of a first frame of the associated traffic identifier having receipt status in the receipt status information of the field set.

14. The computer-readable medium of claim 11, further comprising fifth instructions that produce a respective length field in the acknowledgment frame for each field set that specifies a length of the receipt status information included in the field set.

15. The computer-readable medium of claim 9, further comprising fourth instructions that produce a length field in the acknowledgment frame that specifies the length of the receipt status information.

16. The computer-readable medium of claim 9, wherein the plurality of frames comprises a plurality of MAC service data units or MAC protocol data units.

17. A device adapted to perform communications in a shared resource network, comprising:
a memory adapted to store a plurality of frames; and
a processing unit adapted to generate receipt status information regarding the plurality of frames, and produce an acknowledgement frame comprising the receipt status information, wherein a length of the receipt status information is dependent on a number of the plurality of frames.

18. The device of claim 17, wherein the plurality of frames comprises a plurality of frame subsets each respectively associated with one of a plurality of traffic identifiers.

19. The device of claim 18, wherein the processing unit generates a plurality of field sets in the acknowledgement frame each respectively associated with one of the plurality of traffic identifiers, wherein each field set includes at least one sequence number and receipt status information of frames of the associated traffic identifier, and wherein receipt status information of a field set has a length that is dependent on a number of frames of the associated traffic identifier.

20. The device of claim 19, wherein the receipt status information in each field set respectively comprises a block acknowledgment bitmap.

21. The device of claim 19, wherein the at least one sequence number included in each field set respectively comprises a sequence number of a first frame of the associated traffic identifier having receipt status in the receipt status information of the field set.

22. The device of claim 17, wherein the device comprises a wireless local area network device, and wherein the acknowledgement frame comprises a media access control frame.

23. The device of claim 17, further comprising a shared resource interface, wherein the plurality of frames are received by the device on the shared resource interface.

24. A method of requesting acknowledgement information, comprising:
generating an acknowledgement request frame for requesting receipt status information of a plurality of frames;
specifying a plurality of traffic identifiers in the acknowledgement request frame, wherein each of the plurality of traffic identifiers is associated with at least one of the plurality of frames; and
addressing the acknowledgment frame to a receiver station.

25. The method of claim 24, wherein generating further comprises inserting a control field that specifies the acknowledgement request frame is a request for receipt status of at least one of MAC service data units or MAC protocol data units.

26. The method of claim 24, wherein generating further comprises specifying a starting sequence control number for each of the plurality of traffic identifiers.

27. A memory for storing data for access by a program being executed on a data processing system, comprising:
a data structure stored in the memory including information for verifying receipt of a plurality of frames, the data structure including:
a field that has a sequence number of a first frame of the plurality of frames; and
acknowledgment information regarding the plurality of frames, wherein a length of the acknowledgement information is dependent on a number of the plurality of frames.

28. The memory of claim 27, wherein the acknowledgment information comprises a block acknowledgment bitmap.

29. The memory of claim 27, wherein the data structure further includes:
a second field that has a sequence number of a second frame; and
acknowledgment information regarding a second plurality of frames that includes the second frame, wherein a length of the acknowledgment information regarding the second plurality of frames is dependent on a number of the second plurality of frames.

30. The memory of claim 29, wherein the first frame and the second frame are respectively associated with a first traffic identifier and a second traffic identifier.

31. A computer-readable medium having computer-executable instructions for execution by a computer system, the computer-executable instructions for performing a method of generating an acknowledgment request frame, the computer-executable instructions comprising:
first instructions that generate a first plurality of fields that each have one of a plurality of sequence numbers;
second instructions that generate a second plurality fields that each have a respective traffic identifier associated with one of the plurality of sequence numbers; and
third instructions that produce the acknowledgment request frame that includes the first plurality of fields and the second plurality of fields.

32. A device adapted to generate frame acknowledgment information, comprising:
means for generating a field that has a sequence number of a first frame;
means for generating acknowledgment information regarding a first plurality of frames that include the first frame, wherein a length of the acknowledgment information is dependent on a number of the first plurality of frames; and
means for producing an acknowledgment frame that includes the field and the acknowledgment information.

33. The device of claim 32, wherein the means for generating acknowledgment information generate second acknowledgment information regarding a second plurality of frames that has a length dependent on a number of the second plurality of frames, and wherein the first plurality of frames and the second plurality of frames are respectively associated with a first traffic identifier and a second traffic identifier, and wherein the means for producing further include the second acknowledgment information in the acknowledgement frame.

34. A device adapted to generate frame acknowledgement information, comprising:
means for receiving a first plurality of frames;
means for generating receipt status information regarding the first plurality of frames; and
means for producing an acknowledgment frame comprising the receipt status information, wherein a length of the receipt status information is dependent on a number of the first plurality of frames.

35. The device of claim 34, wherein the first plurality of frames is associated with a first traffic identifier, and wherein the means for receiving the plurality of frames receives a second plurality of frames, and wherein the means for generating further generates receipt status information regarding the second plurality of frames that is of a length dependent on a number of the second plurality of frames, and wherein the receipt status information regarding the second plurality of frames is included in the acknowledgment frame by the means for producing the acknowledgment frame.

36. A system for data transmission, comprising:
a shared resource medium;
a transmitter station comprising a shared resource interface, wherein the transmitter station generates a plurality of frames and transmits the plurality of frames on the shared resource medium by the shared resource interface; and
a receiver station comprising a shared resource interface that receives the plurality of frames, generates receipt status information regarding the plurality of frames, produces an acknowledgment frame that is addressed to the transmitter station and that comprises the receipt status information, and transmits the acknowledgment frame on the shared resource medium, wherein a length of the receipt status information is dependent on a number of the plurality of frames.

37. The system of claim 36, wherein the plurality of frames comprises first frames associated with a first traffic identifier and second frames associated with a second traffic identifier, wherein the receipt status information comprises first receipt status information of the first frames and second receipt status information of the second frames.

38. The system of claim 37, wherein the acknowledgement frame comprises the first traffic identifier in association with the first receipt status information and the second traffic identifier in association with the second receipt status information.
